(19) United States
(12) Patent Application Publication
(10) Pub. No.: US 2021/0287536 A1
(43) Pub. Date: Sep. 16, 2021

(54) SYSTEMS AND METHODS FOR NEGOTIATION AND AUGMENTED REALITY VISUALIZATION OF A PATH THROUGH STATIONARY TRAFFIC

(71) Applicant: PCMS Holdings, Inc., Wilmington, DE (US)

(72) Inventors: Sanni Siltanen, Klaukkala (FI); Jussi Ronkainen, Oulu (FI); Jani Mantyjarvi, Oulunsalo (FI); Mikko Tarkiainen, Tampere (FI)

(21) Appl. No.: 16/326,622

(22) PCT Filed: Aug. 23, 2017
(86) PCT No.: PCT/US2017/048280

§ 371 Date: Feb. 19, 2019

Related U.S. Application Data
(60) Provisional application No. 62/380,802, filed on Aug. 29, 2016.

(51) Int. Cl. G08G 1/0965; G06T 13/20; G06T 19/00; G01C 21/34

(52) U.S. Cl. CPC G08G 1/0965; G06T 13/20; H04W 4/46; G01C 21/3461; G06T 19/006

(57) ABSTRACT

Systems and methods described herein are provided for detecting, by an approaching vehicle, that a path is blocked by one or more blocking vehicles and sending a series of negotiation messages to determine if the blocking vehicles are able to move out of the way. Capability and surroundings request messages are sent to each blocking vehicle to determine if each blocking vehicle indicates permission to move to enable the approaching vehicle to move along the path. Blocking vehicles also respond with three-dimensional data of the environment around each blocking vehicle. Feasibility of moving out of the way is determined and if feasible, each blocking vehicle is commanded to move out of the way of the path. The approaching vehicle continues traversing along the path if the blocking vehicles have been moved out of the way.

### CROSS-REFERENCE TO RELATED APPLICATIONS

The present application is a non-provisional filing of, and claims benefit under 35 U.S.C. § 119(e) from, U.S. Provisional Patent Application Ser. No. 62/380,802, entitled “Systems and Methods for Negotiation and Augmented Reality Visualization of a Path Through Stationary Traffic,” filed Aug. 29, 2016, the entirety of which is incorporated herein by reference.

### BACKGROUND

In traffic, stationary vehicles typically block all vehicles going in a certain direction, including those vehicles with a path that does not cross the root cause for stopping. For example, a driver of a car or other vehicle may wish to turn right at an intersection a few vehicles ahead, but the vehicle may not be able to reach the intersection or enter the right turn lane because the path to the intersection is blocked by vehicles that are driving straight but may not proceed because of red lights or blocking traffic after the intersection. Similarly, large vehicles that use more room when turning in an intersection may be blocked from moving if vehicles waiting to turn onto the crossing road do not leave enough room for the maneuver.

For the first example, the driver may start to pass stationary vehicles from the right, but the driver often may not see whether the path is clear all the way to the intersection. The driver lacks an effective means to communicate to all of the blocking vehicles. An individual human driver lacks the ability to coordinate the operation, and a path that bypasses the block may not be made even if there was enough space to do so.

### SUMMARY

Systems and methods described herein enable the ability to navigate through stationary traffic by communicating with blocking vehicles to make space for a bypass path (or the original path) given evasive maneuvers previously negotiated with other stationary vehicles. The disclosure explains how a vehicle approaching a vehicle queue from behind detects that the approaching vehicle's path is blocked, requests or otherwise initiates a process, and controls queue vehicles to make space by moving. This process is carried out by using an augmented reality user interface, vehicles' sensors, sensor data processing units, and controlled movements of vehicles in front. V2V communication is used to communicate procedures.

Systems and methods described herein, in response to detecting a blockage of an initial path by an approaching vehicle, calculate at least one candidate path by (1) identifying at least one blocking vehicle along the candidate path, (2) sending, to at least one blocking vehicle, a request for capability and surrounding information, (3) in response to the request, receiving respective responses from at least one blocking vehicle, each response providing (i) an indication of permission to move the respective blocking vehicle and (ii) three-dimensional data of the environment around the respective blocking vehicle, and (4) in response to a determination that (i) each of the blocking vehicles of the candidate path have indicated a permission to be moved, and (ii) the three-dimensional data of the environment around the blocking vehicles of the candidate path indicates feasibility of moving out of the way of the candidate path, selecting the candidate path as a bypass path; send, to each of the blocking vehicles of the bypass path, movement request information for causing each of the blocking vehicles of the bypass path to move out of the way of the bypass path; and cause the approaching vehicle to move along the bypass path.

### BRIEF DESCRIPTION OF THE DRAWINGS

A more detailed understanding may be had from the following description, presented by way of example in conjunction with the accompanying drawings.

FIG. 1A illustrates of an exemplary user interface for indicating a user preference to turn right.

FIG. 1B illustrates an exemplary user interface for indicating a calculated approaching vehicle stopping position.

FIG. 1C illustrates exemplary user interface for indicating a user preference for an approaching vehicle destination.

FIG. 1D illustrates an exemplary user interface for indicating affected vehicles.

FIG. 1E illustrates an exemplary user interface for indicating upcoming movements of affected vehicles.

FIG. 1F illustrates an exemplary user interface for indicating a user vehicle is clear to turn right.

FIG. 2 is a system diagram of a system for visualizing a path through stationary traffic.

FIG. 3 is a plan view schematic of a blocking vehicle scenario.

FIG. 4 is a flowchart for a queue bypass based on controlled movement of other vehicles.

FIG. 5 is a flowchart for a vehicle requesting to bypass a queue of vehicles.

FIGS. 6A-6B are a message sequencing diagram for a method of negotiation to bypass a vehicle queue.

FIG. 7A illustrates an exemplary user interface for a user request to turn right.

FIG. 7B illustrates of an exemplary user interface for indicating that a blocking vehicle is unable to move out of the way.

FIG. 7C illustrates an exemplary user interface for indicating an alternate route and upcoming movements of affected vehicles.

FIG. 7D illustrates an exemplary user interface for indicating a user vehicle is clear to turn left.

FIG. 8A depicts an example wireless transmit/receive unit (WTRU) that may be used in some embodiments.

FIG. 8B depicts an exemplary network entity that may be used in some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . .” For brevity and clarity of presentation, this implied leading clause is not repeated ad nauseum in the detailed description of the drawings.

### DETAILED DESCRIPTION

A stationary traffic situation exists where at least one vehicle is blocked from progressing because other vehicles are unable to move. For example, driving straight through an intersection is blocked by a red light and traffic on the other side of the intersection, but turning right on red is an available option. Another example is a bus that is unable to turn in an intersection because cars on the intersecting road are not leaving enough room to accommodate the wide turn radius of the bus.

In these cases, for stationary vehicles that are connected or autonomous, systems and methods are determined herein for automatically rearranging the positioning of the blocking vehicles so that another vehicle may pass. The vehicle intending to pass may communicate negotiation messages with the blocking vehicles to create a clear path. Embodiments disclosed herein further describe techniques for displaying to a driver the results of the electronic negotiation. Drivers may also be informed of circumstances in which an operation may not be performed automatically due to a traffic-based restriction. In some embodiments, an alternate route may be displayed to and accepted by the driver for a bypass maneuver.

Existing systems for autonomous path selection focus mostly on safety aspects where vehicles estimate each other's movement and choose a likely safe path to avoid collision. For autonomous vehicles, traffic jam assistants (TJAs) ensure that vehicles stay in the correct lane and at a close distance to the vehicle ahead.

Autonomous vehicles in exemplary embodiments are able to maneuver within tighter spaces than human drivers. If a bypassing route may be negotiated, more vehicles may pass through a traffic situation side by side with very little clearance. However, even vehicles with an automation Level 3 (L3) may be driven in manual mode in crowded situations or city streets, and drivers may inadvertently block the road from cars that otherwise may proceed. However, similar to current traffic jam assistants and parking assistants, L2 and L3 autonomous vehicles in manual mode may perform limited and coordinated autonomous maneuvers, enabling other vehicles to request a clearance of space via coordination and negotiation between the vehicles. Situational awareness may be maximized by making information available and performing actions based on the environment as visible from car windows.

Systems and methods described herein enable a vehicle approaching a vehicle queue from behind to control queue vehicles to make space and move. This procedure uses an AR UI, vehicle sensors, and sensor processing units, and controlled movements of vehicles in front of the approaching vehicle. V2V communication is used to communicate procedures.

Systems and methods described herein enable driving path planning to be more efficient in congested, urban environment compared to traditional route planning methods (e.g., Waze and Google Traffic). Systems and methods described herein enable better traffic flow by communicating with blocking vehicles in traffic jams and performing vehicle placement negotiations. An exemplary user interface displays upcoming vehicle operations and controls related to the traffic situation. Systems and methods detect stationary and other obstacles and determines whether a path to bypass the obstruction may be created. If such a path may not be created, the user interface displays the reason (such as, a certain blocking vehicle is unable to move out of the way). Systems communicate and coordinate with other vehicle navigation systems, automatically detect where a driver wants to go, and automatically send negotiation messages to other vehicles to determine if sufficient space is available. Systems may also command blocking vehicles to move in non-traffic jam situations, such as if the last vehicle in a vehicle queue is blocking access to a turning lane.

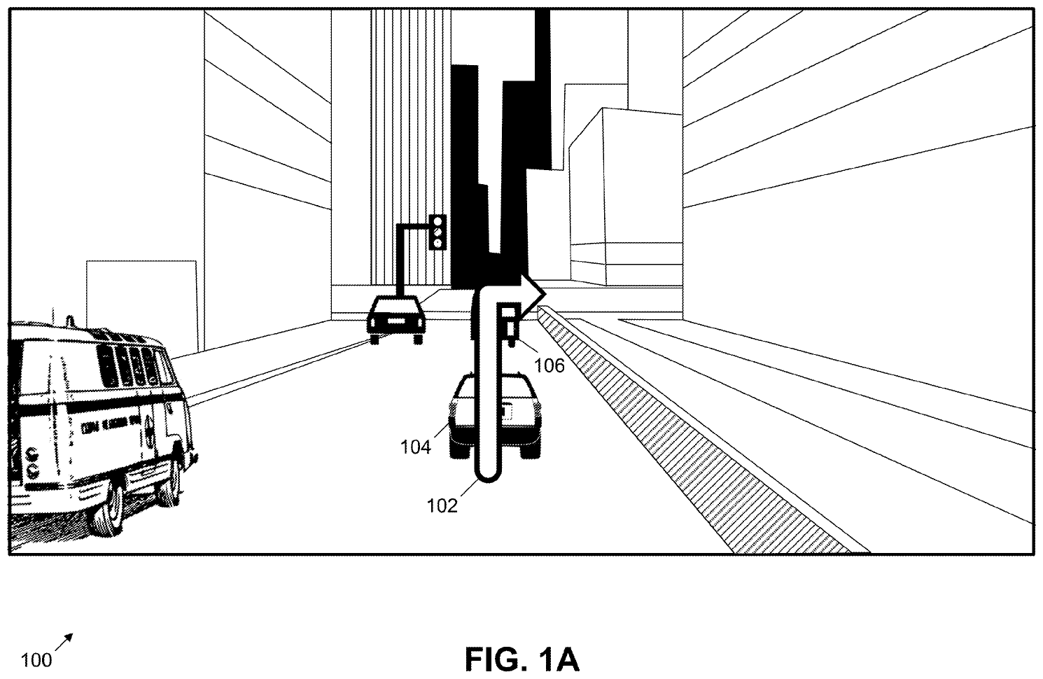

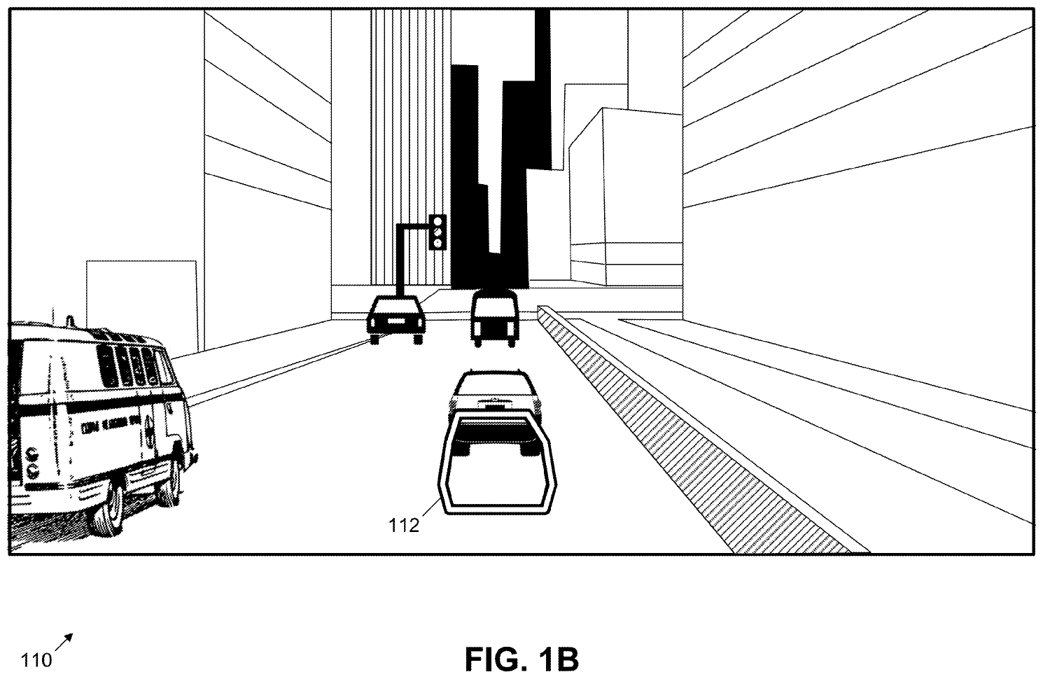

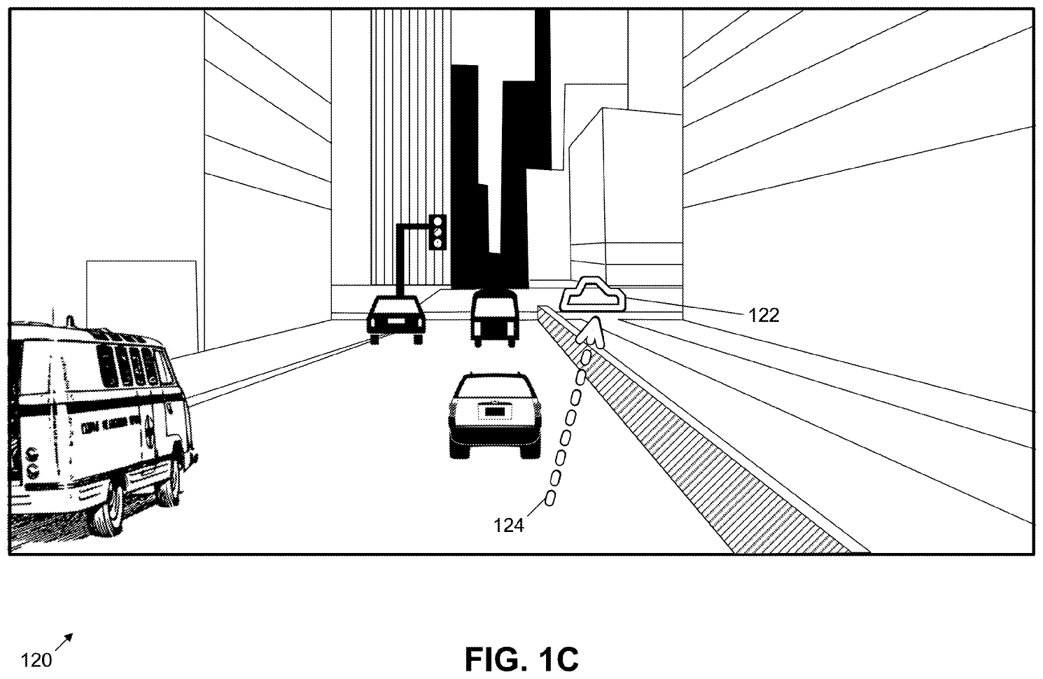

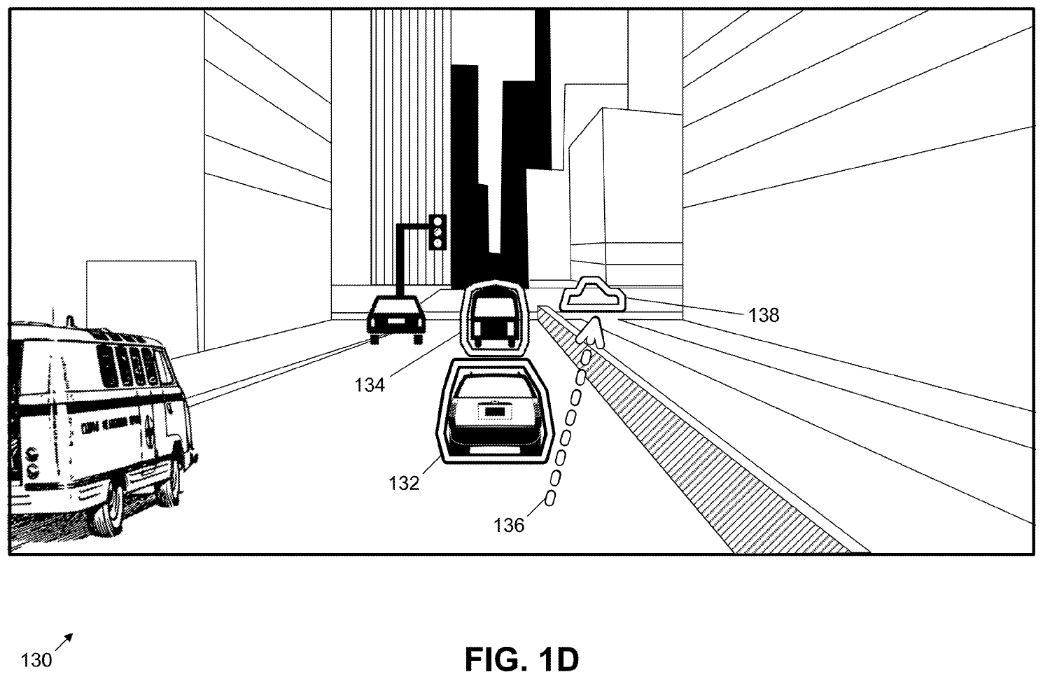

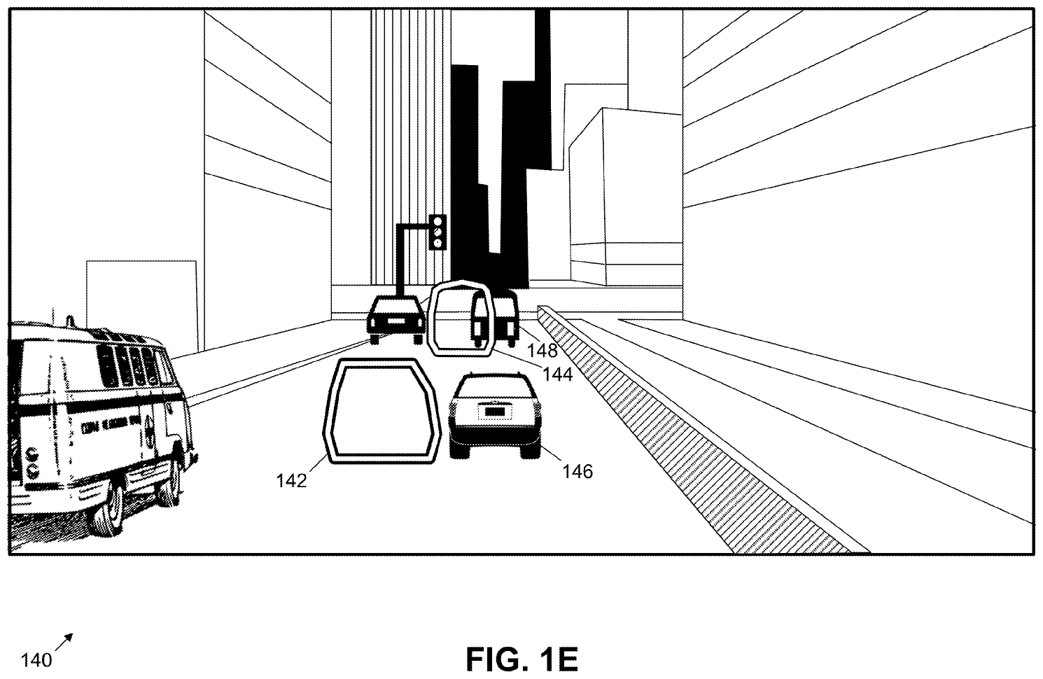

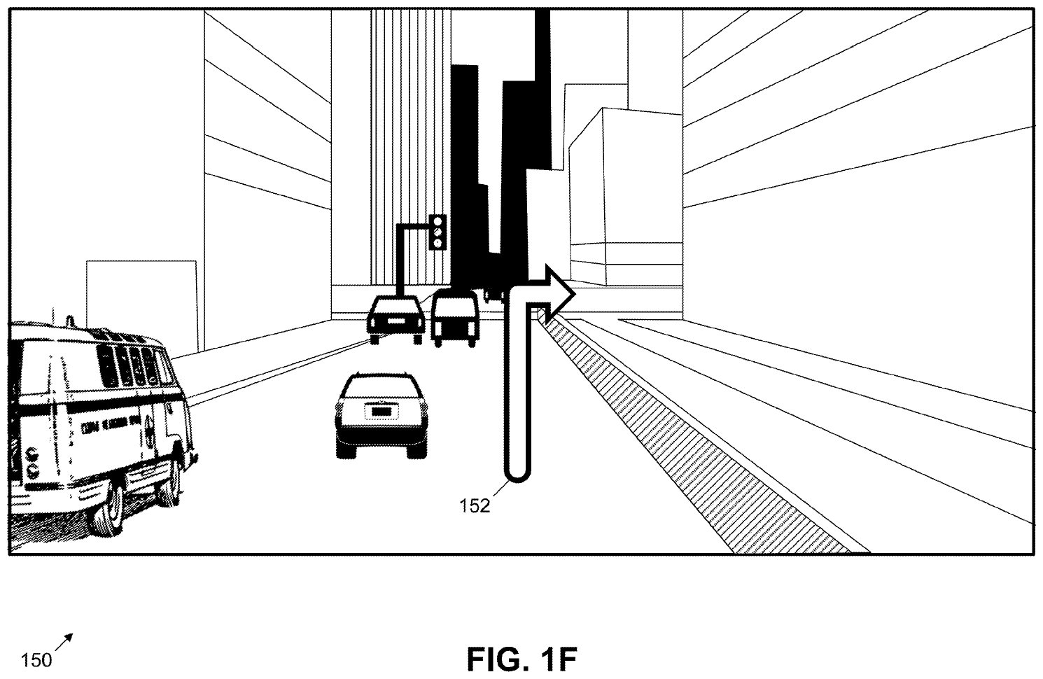

FIGS. 1A to 1F indicate a series of user interface images for a sequence of vehicle movements for vehicles blocking an approaching vehicle's upcoming turn. In FIG. 1A, an approaching vehicle recognizes an opportunity to proceed despite traffic in front of the approaching vehicle being blocked. For one example user interface 100, the white arrow 102 pointing right indicates an upcoming right turn in the approaching vehicle's current route. Vehicles 104, 106 in front of the approaching vehicle are currently stuck because vehicles on the other side of the intersection are stopped.

FIG. 1B shows a user interface 110 with a white outline 112 (or an icon) of the calculated upcoming location of the approaching vehicle. For some embodiments, the calculated upcoming location is an estimated stopping location of the approaching vehicle. When the driver of the approaching vehicles places a hand near the user interface (or windshield for some embodiments), a “ghost car” 112 appears. This image 112 is shown as a white outline 112 of the calculated upcoming location of the approaching vehicle.

FIG. 1C shows a user interface 120 with a white outline 122 (or an icon) of the approaching vehicle's location after a right turn. The dashed arrow 124 indicates the upcoming movement of the approaching vehicle. This upcoming location is chosen by the driver of the approaching vehicle moving a hand in front of the user interface. As the driver moves a hand in front of the user interface 120, the white outline 112 shown in FIG. 1B moves to the location shown in FIG. 1C (e.g. using a drag-and-drop technique). For some embodiments, an icon indicates a future location of the approaching vehicle in response to an interaction with the driver of the approaching vehicle.

FIG. 1D shows a user interface 130 with white outlines 132, 134 (or an icon) around two vehicles that are requested to move so that the approaching vehicle may turn right. When the driver of the approaching vehicle moves his or her hand away from the user interface 130, the ghost car 138 (which may also include a dashed arrow 136) becomes stationary to indicate the future location of the approaching vehicle. Placement of the ghost car 138 causes a system to search for vehicles in the path of the approaching vehicle and to calculate the amount of space that is available for the approaching vehicle's upcoming maneuver. The white outlines 132, 134 around the blocking vehicles flash on and off to indicate that they are being requested to move. Move request messages are transmitted to the two blocking vehicles so that the approaching vehicle may have space to proceed within safety margins. For some embodiments, clearing the path may cause vehicles not blocking the way per se to move so that a blocking vehicle may move out of the way.

FIG. 1E shows a user interface 140 with solid white outlines 142, 144 (or an icon) for the upcoming locations of the blocking vehicles 146, 148 calculated to enable the approaching vehicle to bypass the vehicle queue. These changes to the user interface 140 occur after the blocking vehicles 146, 148 have transmitted back positive messages indicating acceptance of the requested movements.

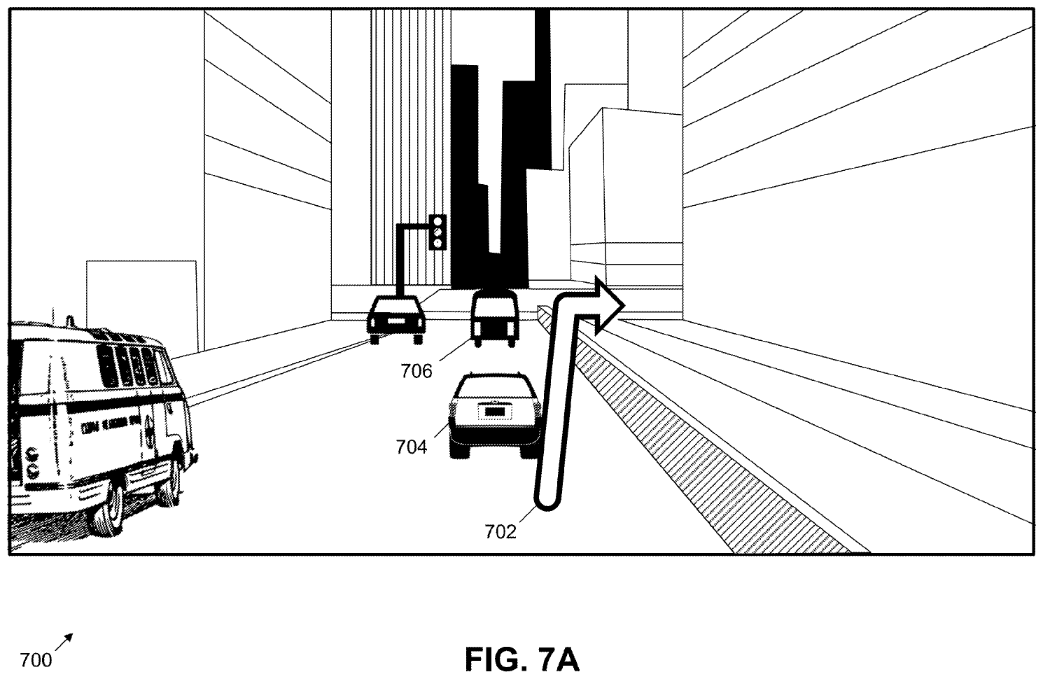

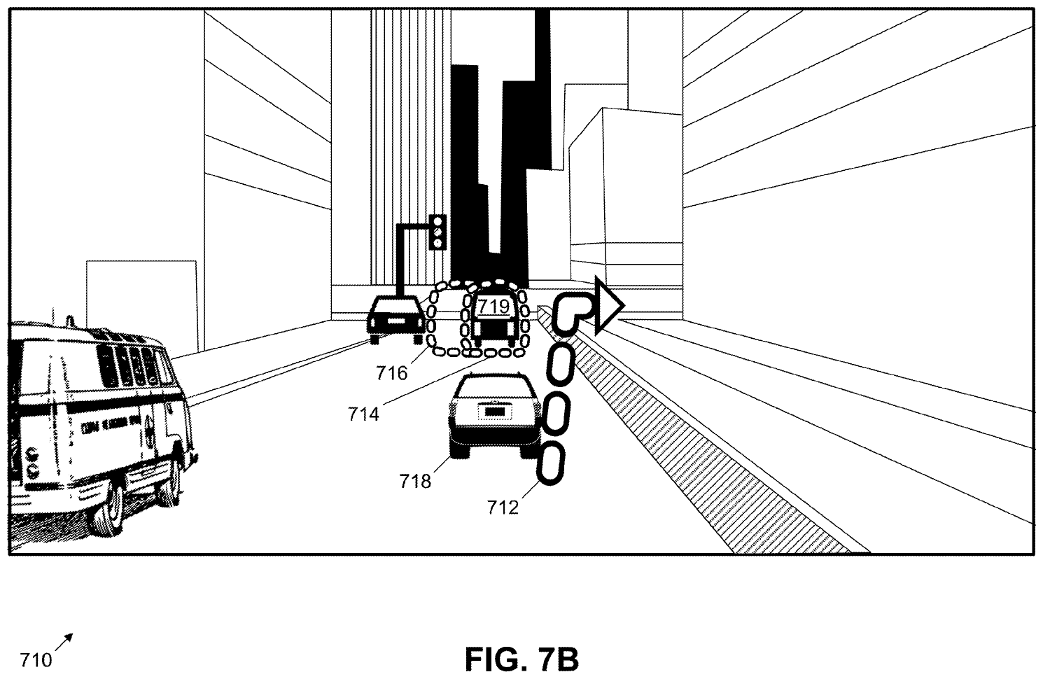

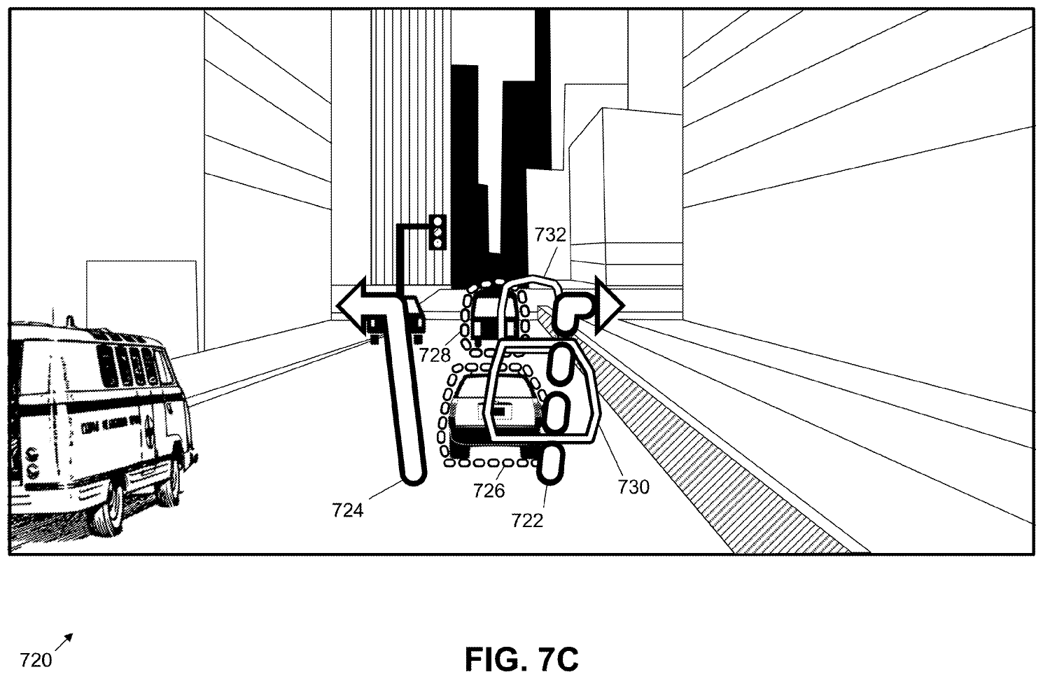

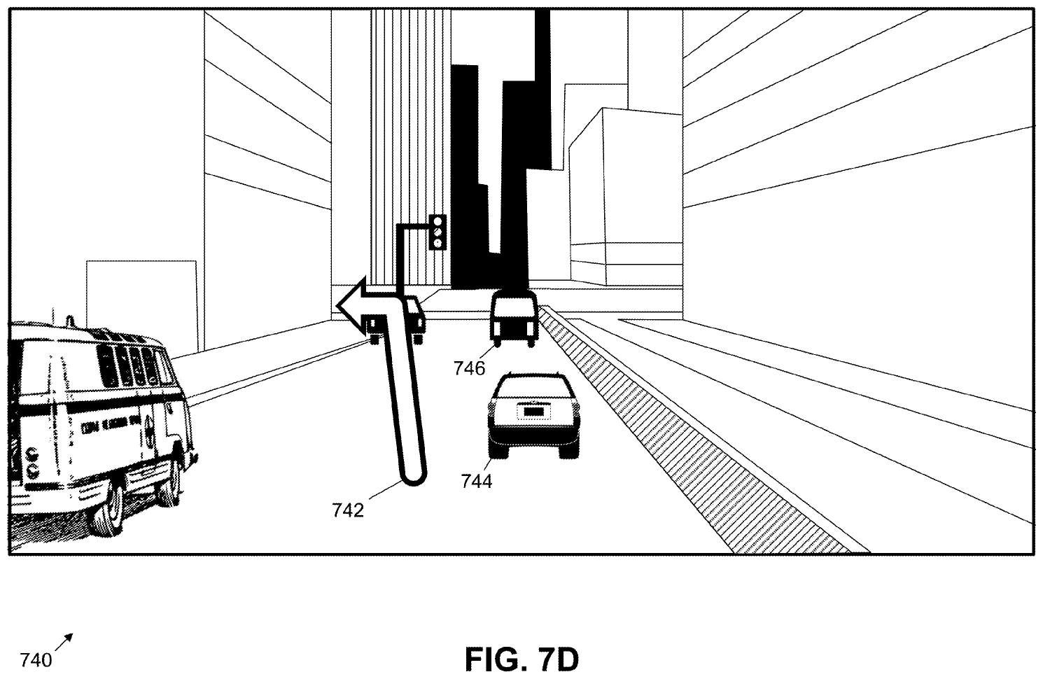

FIG. 1F shows a user interface 150 with the clear pathway for the approaching vehicle after the blocking vehicles have moved out of the way. The white arrow 152 indicates to the driver of the approaching vehicle the ability to make the right turn. FIGS. 7A to 7D later show alternative user interface functionality.

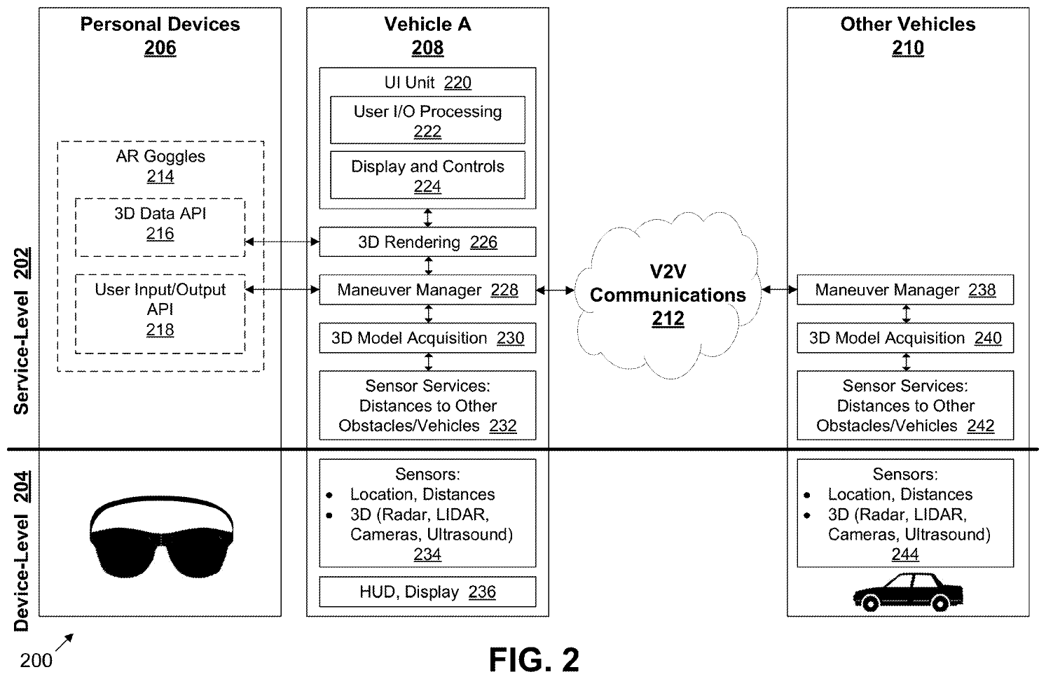

FIG. 2 shows a system diagram of the architecture 200 for the devices 204 and services 202 used by the methods and systems described herein. An exemplary embodiment of a system comprises of a user's personal devices 206, a vehicle A 208, and other vehicles 210 connected by V2V communication 212. An example of a user's personal device 206 is optional AR goggles 214. For some embodiments, such a device may have a 3D data application programming interface (API) 216 and a user input/output API 218. For some embodiments, a processor may be used to perform the methods described in this specification.

Vehicle A 208 may be the approaching vehicle described in FIGS. 1A to 1F. Vehicle A 208 coordinates negotiation for creating a path to bypass blocking vehicles. Vehicle A 208 may have the following modules (among other devices): a UI unit 220, a 3D model acquisition unit 230, a maneuver manager 228, a 3D rendering module 226, and sensor services 232. A user interface unit 220 is used to display and control UI elements 224 and to process user I/O 222, to enable a user to rearrange controls and information elements, and to obtain user input. The 3D model acquisition module 230 calculates a 3D model of the environment surrounding Vehicle A 208. The module 230 detects drivable surfaces (road surface and other road infrastructure features) and other vehicles in the environment. For some embodiments, the 3D model is aligned with a street map using vehicle A's sensors 232 (e.g., radar, lidar, and ultrasound systems) and 3D models received from other vehicles. The maneuver manager 228 calculates a path option to bypass blocking vehicles. The maneuver manager 228 uses the 3D model as an input to calculate a simulated path close to the edge of the determined drivable space, and to determine which vehicles are blocking the simulated path. The maneuver manager 228 communicates with the affected vehicles 210 (which includes the blocking vehicles and other vehicles that may affect whether a blocking vehicle is able to move). The affected vehicles may respond with an affected vehicle's ability to move. The maneuver manager 228 controls whether to request the affected vehicles perform the movements. The 3D rendering module 226 determines the AR content data to display on a user interface 220. Sensor services 232 processes sensor readings and provides sensor information to other system components.

Vehicle A's sensors 234 include sensors for measuring location and distances. Vehicle A also has 3D sensors (such as radar, LIDAR, ultrasound, and camera systems) to measure vehicle surroundings. A display with a human-user interface 236 is used to communicate with the driver of Vehicle A 208.

Other vehicles 210 are able to communicate with Vehicle A 208 via V2V communications 210. Vehicle A 208 may communicate with some of the following components: a 3D model acquisition module 240, a maneuver manager 238, and sensor services 242. Each of these modules 238, 240, 242 is similar to the description given above for Vehicle A 208. A 3D model acquisition module 240 within another vehicle 210 may respond to Vehicle A 208 with an acquired model upon request. The maneuver manager 238 determines whether another vehicle 210 is able to comply with a movement request from Vehicle A 208. This determination may occur by simulating driving maneuvers that would meet the path and clearance criteria set by the request. Space available for the maneuver is determined by a vehicle's own sensors 244, and other vehicles' calculated future locations (which may be received from Vehicle A 208). Sensor services 242 and sensor devices 244 in other vehicles 210 are similar to those items described in relation to Vehicle A 208.

### Process for Determining and Negotiating Clearance for a Vehicle

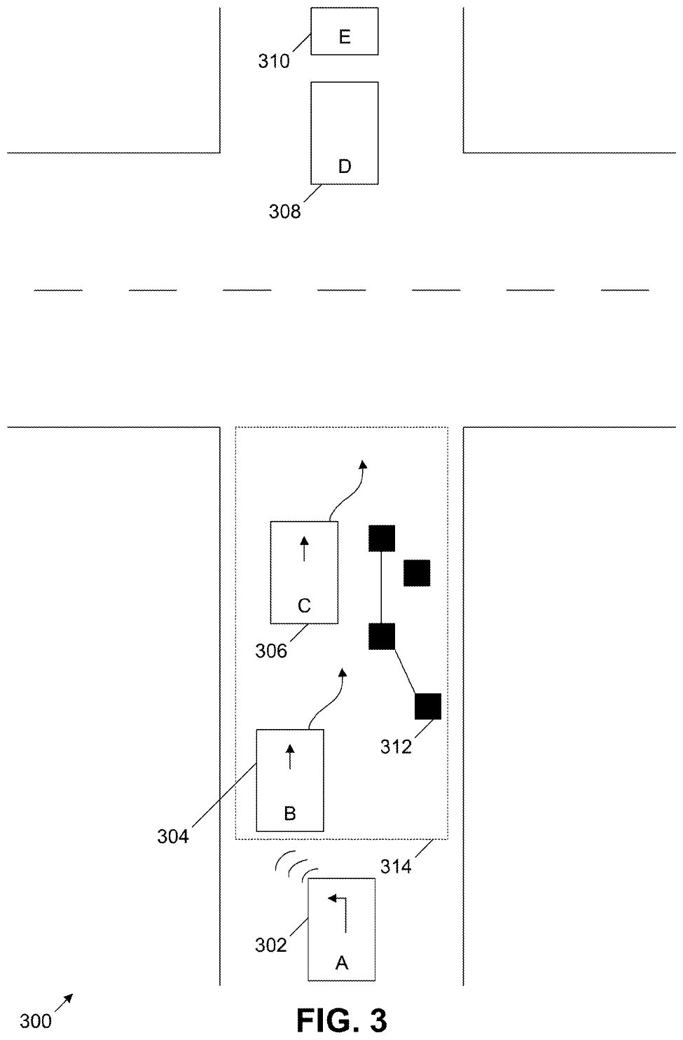

FIG. 3 shows a plan view schematic for an exemplary traffic scenario. The last vehicle in a queue (vehicle A) determines which vehicles are blocking vehicle A's way. Vehicle A communicates with each blocking vehicle to request vehicle movement based on other vehicles performing previously agreed actions. Movements of vehicles B and C are performed only if, as a result of all vehicle movements, vehicle A is able to bypass vehicles B and C.

FIG. 3 shows an example situation 300 where vehicle A 302 plans on making a left turn but is blocked by vehicle B 304 and vehicle C 306. Vehicle B 304 and vehicle C 306 will go straight through the intersection. Vehicle B 304 and vehicle C 306 are unable to move because the other side of the intersection is blocked by vehicle D 308 and vehicle E 310. The road is narrower next to vehicle C because of construction barriers 312. Vehicle C 306 needs to move for vehicle A 302 to bypass. Vehicle B 304 is in the middle of the road and blocking vehicle A's path. Vehicle A 302 communicates with vehicles between Vehicle A 302 and the end of the traffic block 314 (dashed rectangle).

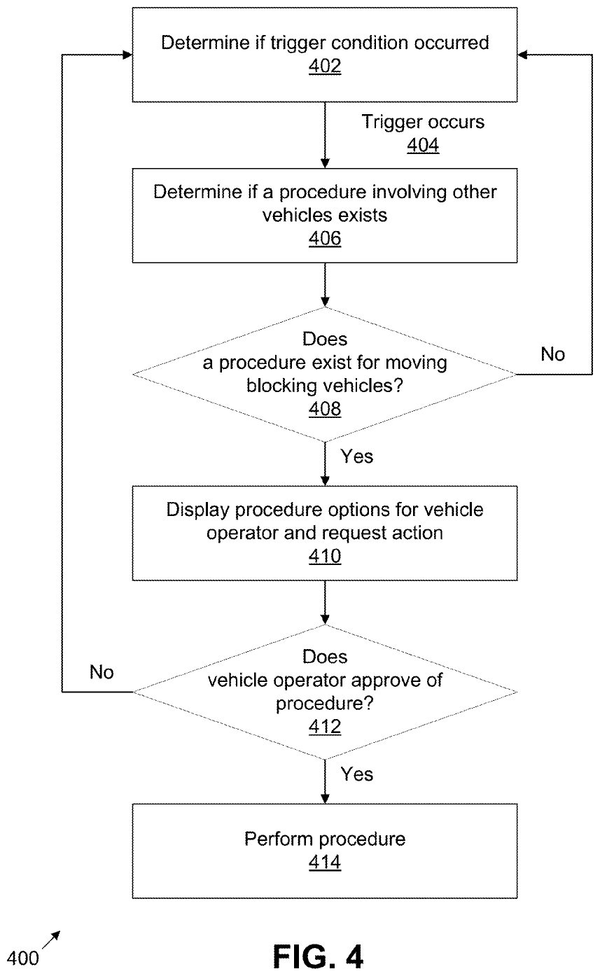

FIG. 4 is a flowchart for bypassing a vehicle queue based on controlled movement of other vehicles. The following description is written for right-hand traffic, but the process 400 is applicable for left-hand traffic as well. A system makes sensor readings and determines 402 if a trigger condition has occurred. If a trigger occurs 404, a system determines 406 if blocking vehicles may be moved out of the way. Other vehicles also may determine if a procedure exists involving vehicles external to those vehicles. If a scenario exists 408 where blocking vehicles may be moved, options will be displayed 410 for the driver. Otherwise, a system will continue determining 402 if a trigger event has occurred. If the driver accepts 412 one of the displayed options, a system will communicate to the blocking vehicles to perform 414 the movements or procedure.

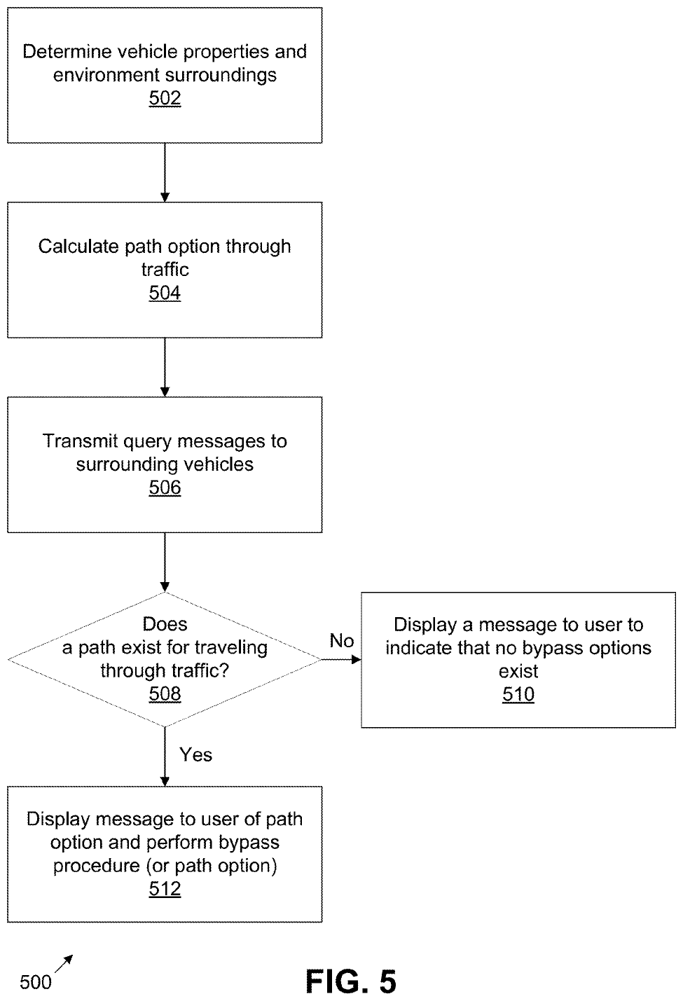

FIG. 5 is a flowchart 500 for bypassing a vehicle queue with more details. An approaching vehicle sends V2V query messages to nearby vehicles to determine 502 vehicle properties and environment surroundings. An approaching vehicle system calculates 504 a path option through traffic. An approaching vehicle system transmits 506 query messages to blocking vehicles to determine whether blocking may be able to move out of the way. If a potential path exists 508, a system displays 512 that option to the user and continues with the process as shown in FIG. 4. If no potential paths exist, a system displays 510 a message to the user to indicate that no potential paths exist.

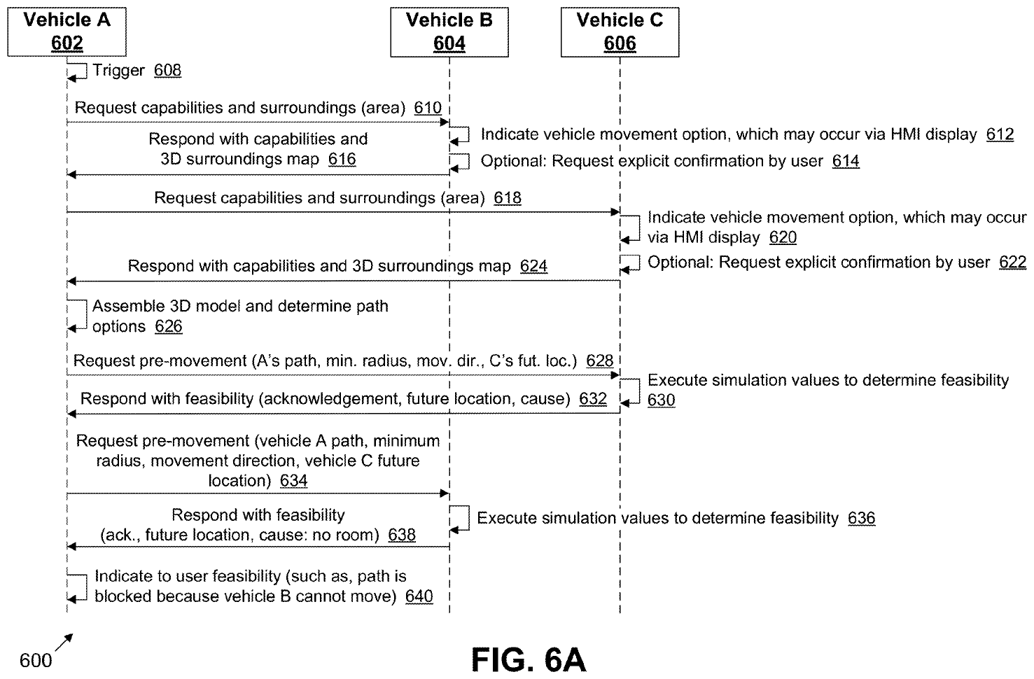

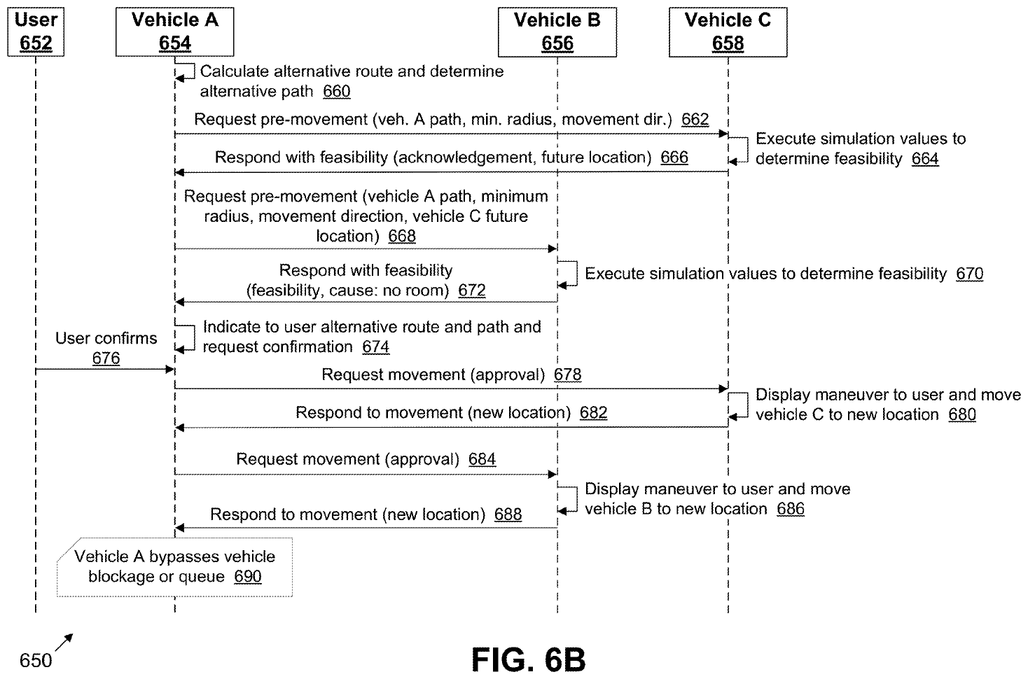

FIGS. 6A and 6B are message sequencing diagrams 600, 650 that show communications among three vehicles: vehicle A 602, 654, vehicle B 604, 656, and vehicle C 606, 658. The sequence diagram shows a case where a vehicle is unable to perform the first path option and a second path option (or alternate or new route) is calculated. Vehicle A 602 calculates the new route, and requests vehicles to move according to the new route. For such a scenario, vehicle A 602 may have a different path than vehicles B 604 and C 606 and a route may be determined from a navigator or via user interaction. Also, vehicles B 604 and C 606 are in front of vehicle A 602.

As shown at the top of FIG. 6A, a trigger 608 is detected by vehicle A 602. Vehicle A 602 determines via sensor readings that its path is blocked by other (stationary) vehicles. Vehicle A 602 also determines that if those blocking vehicles did not exist, vehicle A 602 may continue moving.

Vehicle A 602 requests 610, 618 capabilities and surroundings (or query) from vehicle B 604 (and from vehicle C 606). Vehicle A 602 sends a request message to all vehicles between its current location and the intersection (e.g., the end of the blocked traffic section) for a report of capability (or an indication of permission) for those vehicles to move if requested, as well as a 3D model of the drivable area detected around each vehicle (or three-dimensional data of the environment around each vehicle). Each vehicle capable of responding to the request sends 616, 624 back a response of whether the vehicle is capable to move if requested and a 3D model of the vehicle's surroundings. The capability does not indicate the actual ability to move (an indication of whether there is enough space) but only permission to move autonomously if requested. For some embodiments, permission may be reported automatically (based on previously entered user preferences). For other embodiments, permission may be requested from the user immediately after receiving a Capability and Surroundings Request message. For some embodiments, permission may be reported automatically as affirmative, and the vehicle will move autonomously if requested. For some vehicles, capability (or permission) may be reported as lacking support if the vehicle lacks the equipment and functionality to move out of the way. Failure to respond with capabilities and a 3D surroundings map 616, 624 may be determined, for example, by combining individual vehicle report messages and data indicating detection of vehicles for the acquired 3D model (or map). If the features of this system are implemented in vehicle B 604 (and vehicle C 606) and vehicle A 602 receives a Capability and Surroundings Response message 616, 624 with an affirmative permission value, vehicle A 602 may send a request message 610, 618 to determine if vehicle B 604 (or vehicle C 606) has enough space and is able to move out of the way. Depending on vehicle mode and user preferences, for some embodiments, responding vehicles 604, 606 may communicate alert messages (and provide control) to operators of a potential vehicle movement. Messages may be communicated 612, 620 using HUD, display, audio, or haptic (such as via vibration). For some embodiments, vehicle B's (or vehicle C's) HMI displays to the operator a move request message. For those embodiments, vehicle B (or vehicle C) waits for an explicit confirmation by the operator before vehicle B sends a response message. A message may be displayed 612, 620 for a driver of each blocking vehicle 604, 606 indicating a potential vehicle movement. A confirmation may be requested 614, 622 (and received) from each driver of each blocking vehicle 604, 606 that indicates a capability (or permission) to move.

Vehicle A 602 assembles 626 a 3D model of the drivable space around the vehicles, based on vehicle A's sensor readings and 3D models (or three-dimensional data of the environment around other vehicles) reported 616, 624 by other vehicles 604, 606. Using this 3D model, Vehicle A 602 calculates potential paths to bypass blocking vehicles 604, 606. For example, a path may be such that an approaching vehicle may pass the blocking vehicles from their right, with the curb as the right-hand boundary of the path. Vehicle A's width plus a safety margin will be used as the width of the path. For some options, a path may follow a physical boundary such as the curb line, but for other options, a path may use a different trajectory.

Vehicle A 602 sends a Pre-Movement Request 628, 632 message to each affected (or target) vehicle in the vehicle queue. For some embodiments, messages are sent to the vehicle the furthest away from vehicle A 602. For other embodiments, messages are sent to the closest vehicle to vehicle A 602. For other embodiments, messages may be sent simultaneously to each vehicle in the vehicle queue. A Pre-Movement Request 628, 634 message may contain four or five fields: vehicle A path, minimum distance to the path, movement direction, future location of the affected vehicle, and optionally, a future time window for the operation. The vehicle A path field is a description of the potential path (for example, a spline). The minimum distance to the path field is the minimum distance (radius) from the extremities of the affected vehicle to the path. The movement direction field is the movement direction of the vehicle in front or behind the vehicle receiving the message. The future location of affected vehicle field is the future location of the vehicle in front or behind the vehicle receiving the message depending on the direction vehicle A is sending messages in the vehicle queue.

Each affected (or target) vehicle calculates (or executes 630, 636 a simulation) whether the affected vehicle is able to maneuver within the confines of an optional path. For some embodiments, this calculation is a determination of feasibility of moving out of the way of the approaching vehicle's path. For some embodiments, this calculation is based on the future location of the vehicle in front or behind the affected vehicle depending on the direction vehicle A is sending messages in the vehicle queue. Each affected vehicle will determine if the affected vehicle is able to move laterally, forward, and/or reverse. Each affected vehicle may determine how to maneuver. Such maneuvers may include reverse movement as long as the affected vehicle is not behind the affected vehicle's location prior to the maneuver. Affected vehicles may communicate the planned path to the driver, such as by displaying a message on a heads-up display (HUD) or communicating an audio signal to the driver.

A Pre-Movement Response 632, 638 message is sent by each affected vehicle in response to a Pre-Movement Request 628, 634 message. A Pre-Movement Response 632, 638 message contains three fields: a preliminary acknowledgement, a future location, and a cause. The preliminary acknowledgement field indicates whether a vehicle will comply with a request if a formal Movement Request message is sent. The future location field is the location of the affected vehicle as a result of the maneuver. The data from this field may be used with a 3D model to show the vehicle with respect to its current location. The cause field is an indication of the reason the target vehicle will not comply or is unable to comply (e.g., the affected vehicle may not be able to maneuver due to lack of space). This field may be used for communicating to vehicle A's driver why a bypass will not work. Feasibility may be determined based on executed simulation values 630, 636. For the example shown in FIG. 6A, vehicle B 604 responds with an inability to perform the maneuver due to a lack of room, and this feasibility is indicated 640 to a user.

For some embodiments, vehicle A 602 requests forward movement maneuvers. If any of the affected vehicles are unable to comply, vehicle A 602 may request reverse movement maneuvers. If any of the vehicles are unable to comply with the reverse maneuvers, vehicle A may request a further combination of forward and reverse maneuvers. For other embodiments, vehicle A 602 may send a request to affected vehicles, and each affected vehicle may determine whether the affected vehicle is able to perform any maneuver in a series of forward, reverse, or combination movements. Vehicle A 602 may combine movements and for example, request each vehicle in a queue move forward or for the front half the queue to move forward and the back half of the queue to move backward. If an optional path is determined, the path is communicated to the vehicle A driver. This communication may be a series of movements on a display (or HUD) showing the movements of the affected vehicles. For some embodiments, an audio signal of future vehicle movements may be communicated to the driver.

FIG. 6B shows the continued messaging 650 if the bypass options did not work or if at least one blocking vehicle determines that the blocking vehicle is incapable of moving out of the way of the path. If vehicle A 654 is unable to determine a viable option for bypassing blocking vehicles, vehicle A 654 may calculate an alternate route. Vehicle A 654 calculates 660 a new path to bypass the vehicle queue (such as turning left instead of right). Vehicle A 654 sends Pre-Movement Requests 662, 668 to vehicles B 656 and C 658 for the new path. Vehicles B 656 and C 658 may execute simulation values to determine feasibility 664, 670. If each affected vehicle responds 666, 672 affirmatively, vehicle A 654 may display 674 a confirmation message for vehicle A's driver. For some embodiments, a message communicating 674 the alternate route may be displayed for a driver 652 of the approaching vehicle. The driver 652 may confirm 676 the alternate route by interacting with the user interface to indicate approval to use the alternate route as the path. If the driver of vehicle A 654 denies the confirmation, vehicle A 654 may remain idle until the vehicle queue disappears. If the driver 652 of vehicle A 654 responds with a confirmation for the new route, vehicle A 654 may send Movement Request messages 678, 684 to vehicles B 656 and C 658. The Movement Request 678, 684 (or movement request information) messages may be sent in accordance with the acknowledged maneuvers and in sequence with distance from vehicle A 654. Vehicle B 656 and Vehicle C 658 drivers see on their displays 680, 686 (or HUD) the upcoming maneuver (e.g., by animating on the HUD the future movement of the vehicles in front of vehicle A 654 and the movement of the vehicle A 654). Vehicles B 656 and C 658 autonomously move to their new locations (or move out of the way of the path) and send messages to vehicle A 654 with their new locations 682, 688. For some embodiments, the vehicles may originally be in manual mode and, after informing the users of the affected vehicles, briefly enter autonomous mode to perform the maneuver and return to manual mode. Automated movement may be performed automatically as soon as a path is determined or, for example, after confirmation from vehicle A's driver. After a clear path is available, vehicle A 654 bypasses 690 the vehicle queue in manual or autonomous mode. For some embodiments, the approaching vehicle moves or traverses along the path.

For some embodiments, an alternate route may be calculated if a determination is made that at least one blocking vehicle is incapable of moving out of the way of the original path. Each of the blocking vehicles may receive a pre-movement request information (or a Pre-Movement Request message) for the alternate route. For some embodiments, the rest of the process for an alternate route is similar to a process for the original path.

FIGS. 6A and 6B form a message sequencing diagram for a series of negotiation messages and user interface actions between the originating vehicle (vehicle A 602) and affected (or in some cases, blocking) vehicles in front of vehicle A 602. For this example, vehicle B 604 is in front of vehicle A 602, and vehicle C 606 is in front of vehicle B 604. The messages sequence shows an example case where Vehicle B 604 is unable to fulfil the first movement request. Vehicle A 602 calculates an alternate route and requests affected vehicles move accordingly. Vehicle A's driver confirms the route change before movement requests are sent to other vehicles. The messages shown in FIGS. 6A and 6B are described below.

For a Capability and Surroundings Request message 610, 618, vehicle A 602 determines the area where vehicle A's path is blocked. Vehicle A 602 sends Capability and Surroundings Request 610, 618 messages to vehicles within that blocking area. This message contains one field: area. The area field is a description of region blocking vehicle A's path. This description may be a polygon of latitude and longitude coordinates.

For a Capability and Surroundings Response 616, 624 message, affected vehicles that are capable of responding to such a message and within the blocking area respond with their capability (or permission) to move if requested. The response 616, 624 also includes a 3D map of the affected vehicle's surroundings based on the affected vehicle's sensor readings. The capability (or permission) field indicates a vehicle's approval to move if requested. This field may indicate three values: full capability, limited capability, and no capability. If the capability (or permission) field is equal to no capability or limited capability, the affected vehicle's response may include a cause field for some embodiments. The cause field may have a value indicating that a vehicle is in manual mode only or that a vehicle movement is not allowed. The manual mode only value may be sent when the affected vehicle is unable to maneuver autonomously (human driver maneuvering only). The not allowed value may be sent if the vehicle is not allowed to move (such as because of a user preference). The near surroundings map field is a 3D map of the affected vehicle's immediate surroundings. The 3D model may be tied to the vehicle's coordinates. The map may also include other information the vehicle has detected about its surroundings, such as recognized objects (vehicles, pedestrians and other objects), and any data the vehicle has about the recognized objects' capabilities. For some embodiments, the cause field may be displayed on an approaching vehicle's display or HUD. For some embodiments, the cause field may be communicated to the driver of the approaching vehicle to indicate the incapability (or lack of permission) to move by one of the blocking vehicles.

For a Pre-Movement Request message 628, 634, Vehicle A 602 assembles a 3D map of the area from its current location to clear space beyond the blocking queue. Vehicle A 602 uses other vehicles' reported 3D maps and vehicle A's sensor readings. Vehicle A 602 determines a potential path to bypass the blocking vehicles. Vehicle A 602 sends Pre-Movement Request 628, 634 messages to each affected vehicle to determine if those vehicles are able to move out of the way. A Pre-Movement Request 628, 634 message has four fields: vehicle A's path, minimum radius, movement direction, and other vehicle's future locations. The vehicle A path field indicates vehicle A's potential trajectory from its current position to a projected location. The field may indicate, e.g., a spline or a polyline. The minimum radius field is the minimum clearance calculated by vehicle A from the trajectory line in each direction. Because the radius may change along the path, each radius is tied to a point along the trajectory. The movement direction field is the predominant direction in which the affected (or target) vehicle may be commanded to move. This field may be forwards or backwards. Because other affected vehicles may use this field to calculate movements, longitudinal position at the end of the movement is measured in the requested direction from current location. The other vehicles' future locations field is the future location of other affected vehicles near the affected vehicle receiving the message. As Vehicle A 602 sends request messages to blocking vehicles, vehicle A 602 receives the blocking vehicle's planned future location. Vehicle A 602 includes this location (as a 3D model or a bounding box) to further requests to vehicles further down the line in the vehicle queue. Other vehicles may determine more accurately their ability to move when the other vehicles receive this information. Each vehicle will receive at least the position of a vehicle next to them in the designated movement direction.

For a Pre-Movement Response message 632, 638, vehicles respond with their ability to move. If a vehicle may move and make space for a requesting path, the response will contain the future location of the affected vehicle after the move. This message has two or three fields: status, cause (optional for some embodiments), and future location. The status field indicates a vehicle's ability to move to the requested path or location. This field may have a value of status ok or status not ok. If the status has a value of status not ok, an optional cause field may include additional information. The cause field may have values of not enough room or manually declined. A value of not enough room means the affected vehicle lacks the minimum threshold of room to perform the maneuver. A manually declined value means the driver declined the request. The future location field indicates the future location of the affected vehicle. If the status field is status ok, the future location field contains a description of the affected vehicle's future location, such as a 3D model data or a set of coordinates for a bounding box. For some embodiments, the future location field is relative to an affected vehicle's current location.

For some embodiments, an animation of future movements of each vehicle of the plurality of blocking vehicles is displayed on a HUD or vehicle display. For other embodiments, an animation of future movements of each blocking vehicle for an alternate route is displayed on a HUD, vehicle display, or a head-mounted display such as AR goggles. For some embodiments, an incapability (or lack of permission) to move by a blocking vehicle may be displayed on a HUD or vehicle display. For some embodiments, an animation of future movements of an approaching may be displayed on a HUD, vehicle display, or a head-mounted display such as AR goggles.

### Additional Embodiments

A time window may be used in movement requests to indicate a future time when the requested clearance may be available. In that case, each vehicle estimates their position at the end of the time window, and vehicle moves are made based on the time window. Using time windows, vehicles may be in motion during a maneuver or operation. For some embodiments, determining each blocking vehicle's capability (or permission) to move is made based on the capability (or permission) to move during a future time window.

Use of road infrastructure (e.g., traffic light timing) may be used to determine feasibility to perform vehicle maneuvers (or feasibility of moving out of the way of the path). For example, if a block is due to a red light and the light is programmed to change in ten seconds, there may be no time savings for moving vehicles.

If vehicles are in a queue and a path for bypassing vehicles was negotiated (successfully) earlier, one of the vehicles in the queue (such as the last vehicle) may detect that an approaching car may benefit from using a bypass path (e.g., detect signal lights or receive a V2V communication message). Time may be saved by not sending the negotiation (Capability and Surroundings 610, 618 and Pre-Movement 628, 634) messages and sending Movement Request 678, 684 messages immediately. For some embodiments, if a second approaching vehicle is detected (which may be traversing along the path), movement request information may be sent to each blocking vehicle to remain out of the way of the path and to enable the second approaching vehicle to traverse the path. The second approaching vehicle continues moving along the path when a clear passageway has been created (or if the clear passageway remains available).

### Additional User Interface Embodiments

FIGS. 7A to 7D show an additional UI embodiment. Instead of manual triggering (or manual detection based on a user interface interaction) of a bypass negotiation function, such a function may be triggered (or detected) automatically. FIGS. 7A to 7D show a series of UI animations 700, 710, 720, 740 displayed to the driver of an approaching vehicle. In FIG. 7A, the white arrow 702 on a HUD or other display indicates that a right turn is the next maneuver in the driver's route. The blocking vehicles 704, 706 in front of the approaching vehicle will be going straight through the upcoming intersection. The blocking vehicles are stuck due to vehicles on the other side of the intersection.

FIG. 7B shows an embodiment of the user interface 710 for an approaching vehicle. The approaching vehicle sends request messages to blocking vehicles 718, 719 to determine if the approaching vehicle will be able to bypass the blocking vehicles 718, 719 and make a right turn. The vehicle 719 closest to the intersection is unable to move left. This inability is shown in FIG. 7B as two sets of white dashed lines 714, 716. One set of white dashed lines 714 outlines the stopped vehicle, and a second set of dashed lines 716 are located to the left of the stopped vehicle 719 to indicate the stopped vehicle's inability to move left. The right turn arrow 712 is also shown as a dashed white line to indicate that the approaching vehicle will have to wait to turn right.

FIG. 7C shows the user interface 720 when an alternate route is available to an approaching vehicle. The original route included a right turn at the upcoming intersection. The right turn arrow 722 is shown as a dashed line to indicate that the approaching vehicle will wait with this option. An alternate route includes a left turn at the upcoming intersection. The blocking vehicles are outlined with white dashed lines 726, 728. The approaching vehicle sends request messages to the blocking vehicles to determine if those vehicles may move to the right. The blocking vehicles respond with indications that they are able to make room by moving to the right. The future locations of the blocking vehicles are shown as solid white outlines 730, 732 to the right of those vehicles. The left turn arrow 724 is shown as a solid white line with an arrow to indicate that the alternate route is an option in which the blocking vehicles are able to move out of the way. The user may tap on the left arrow to confirm that the user is willing to take an alternate route. The blocking vehicles will make room when the user confirms the alternate route.

FIG. 7D shows a user interface 740 with a white arrow 742 and with the blocking vehicles 744, 746 moved out of the way to indicate that the approaching vehicle may proceed on the alternate route. FIG. 7D shows the user interface 740 after a successful series of negotiation messages for an alternate route. For some embodiments, the series of communications for an alternate route may be made automatically.

### Additional Use Case Example

For one scenario, a hypothetical user, Ted, is in an AV on a one-way street with only one, relatively wide, through direction lane. Ted's AV is approaching an intersection. Ted's planned route turns right at the intersection. The crossing road has low traffic volume, while the road forward after the intersection is blocked. Two vehicles in front of Ted are going straight but are not moving. Ted's vehicle is unable to bypass the blocking vehicles because the vehicle directly in front of Ted's AV is too far right in the lane. The vehicle two vehicles in front of Ted's AV is stopped beside a parked vehicle, making the road too narrow.

Ted's AV sends request messages to the two blocking vehicles to determine if the blocking vehicles may move to the right so that Ted's AV may pass. The first vehicle is able to move, but the second vehicle is unable to move. The “next turn right” arrow on Ted's navigator is yellow (or is a dashed line) to indicate that Ted's AV is unable to perform an automated bypass. Also, the first vehicle (or car) in the queue is outlined with a flashing red left border (or dashed border) to indicate the reason an automated bypass failed.

Ted's AV calculates an alternate route with a left turn. Ted's AV sends request messages to the vehicles in front to determine if the affected vehicles may be able to make space to their left. Both affected vehicles are able to make the moves. An alternate route arrow to the left is shown on the HUD within Ted's AV. The HUD shows an animation where the vehicles in front move to the right to make way. Ted presses on the left arrow to confirm the new route and request that the affected vehicles in front to move out of the way. The affected vehicles move, and Ted continues driving the alternate route.

### Network Architecture

A wireless transmit/receive unit (WTRU) may be used with an AV to communicate negotiation messages with affected vehicles in embodiments described herein.

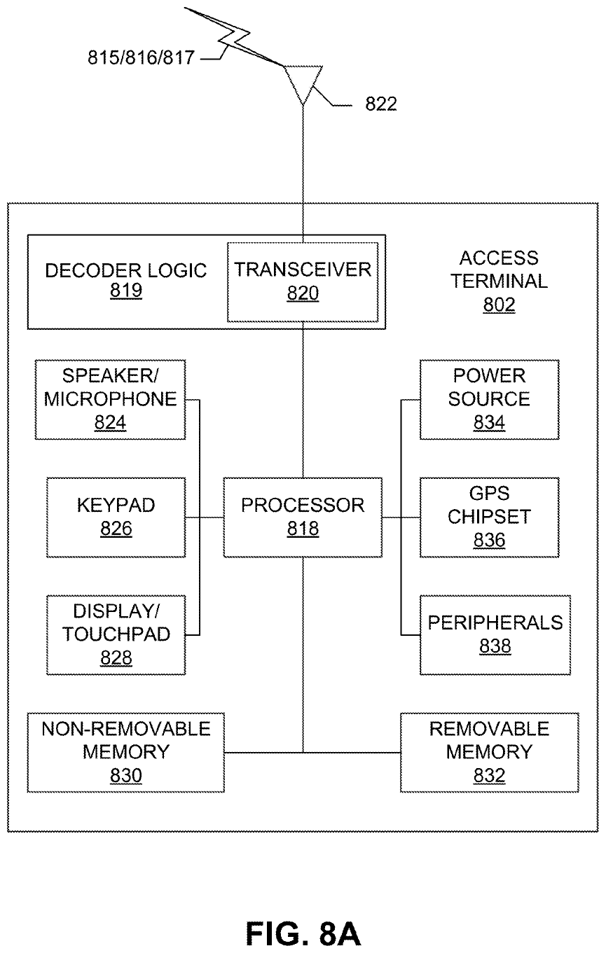

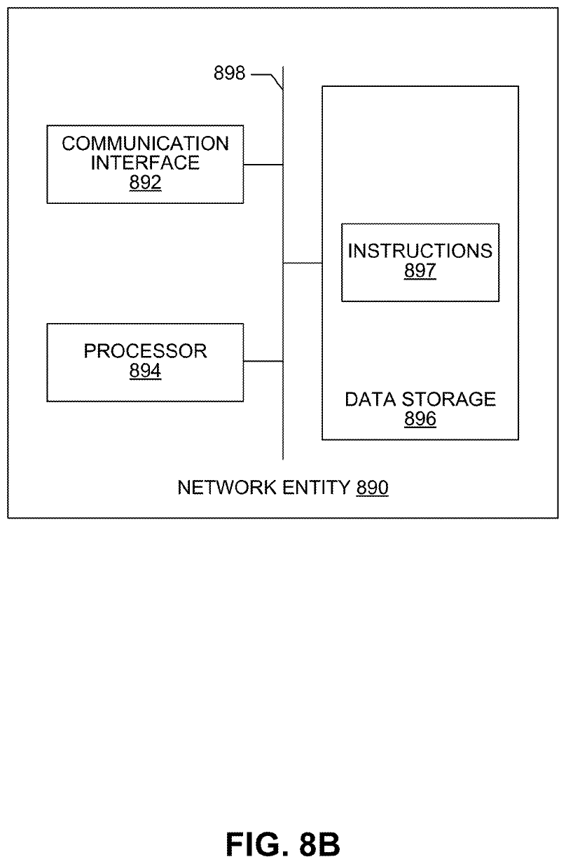

FIG. 8A is a system diagram of an example WTRU 802. As shown in FIG. 8A, the WTRU 802 may include a processor 818, a transceiver 820, a transmit/receive element 822, a speaker/microphone 824, a keypad 826, a display/touchpad 828, a non-removable memory 830, a removable memory 832, a power source 834, a global positioning system (GPS) chipset 836, and other peripherals 838. The transceiver 820 may be implemented as a component of decoder logic 819. For example, the transceiver 820 and decoder logic 819 may be implemented on a single LTE or LTE-A chip. The decoder logic may include a processor operative to perform instructions stored in a non-transitory computer-readable medium. As an alternative, or in addition, the decoder logic may be implemented using custom and/or programmable digital logic circuitry. The WTRU 802 may include any sub-combination of the foregoing elements while remaining consistent with an embodiment.

The processor 818 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 818 may perform signal coding, data processing, power control, input/output processing, and/or any other functionality that enables the WTRU 802 to operate in a wireless environment. The processor 818 may be coupled to the transceiver 820, which may be coupled to the transmit/receive element 822. While FIG. 8A depicts the processor 818 and the transceiver 820 as separate components, the processor 818 and the transceiver 820 may be integrated together in an electronic package or chip.

The transmit/receive element 822 may be configured to transmit signals to, or receive signals from, a base station over the air interface 815/816/817. For example, in one embodiment, the transmit/receive element 822 may be an antenna configured to transmit and/or receive RF signals. In another embodiment, the transmit/receive element 822 may be an emitter/detector configured to transmit and/or receive IR, UV, or visible light signals, as examples. In yet another embodiment, the transmit/receive element 822 may be configured to transmit and receive both RF and light signals. The transmit/receive element 822 may be configured to transmit and/or receive any combination of wireless signals.

In addition, although the transmit/receive element 822 is depicted in FIG. 8A as a single element, the WTRU 802 may include any number of transmit/receive elements 822. More specifically, the WTRU 802 may employ MIMO technology. Thus, in one embodiment, the WTRU 802 may include two or more transmit/receive elements 822 (e.g., multiple antennas) for transmitting and receiving wireless signals over the air interface 815/816/817.

The transceiver 820 may be configured to modulate the signals that are to be transmitted by the transmit/receive element 822 and to demodulate the signals that are received by the transmit/receive element 822. As noted above, the WTRU 802 may have multi-mode capabilities. Thus, the transceiver 820 may include multiple transceivers for enabling the WTRU 802 to communicate via multiple RATs, such as UTRA and IEEE 802.11, as examples.

The processor 818 of the WTRU 802 may be coupled to, and may receive user input data from, the speaker/microphone 824, the keypad 826, and/or the display/touchpad 828 (e.g., a liquid crystal display (LCD) display unit or organic light-emitting diode (OLED) display unit). The processor 818 may also output user data to the speaker/microphone 824, the keypad 826, and/or the display/touchpad 828. In addition, the processor 818 may access information from, and store data in, any type of suitable memory, such as the non-removable memory 830 and/or the removable memory 832. The non-removable memory 830 may include random-access memory (RAM), read-only memory (ROM), a hard disk, or any other type of memory storage device. The removable memory 832 may include a subscriber identity module (SIM) card, a memory stick, a secure digital (SD) memory card, and the like. In other embodiments, the processor 818 may access information from, and store data in, memory that is not physically located on the WTRU 802, such as on a server or a home computer (not shown).

The processor 818 may receive power from the power source 834, and may be configured to distribute and/or control the power to the other components in the WTRU 802. The power source 834 may be any suitable device for powering the WTRU 802. As examples, the power source 834 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 818 may also be coupled to the GPS chipset 836, which may be configured to provide location information (e.g., longitude and latitude) regarding the current location of the WTRU 802. In addition to, or in lieu of, the information from the GPS chipset 836, the WTRU 802 may receive location information over the air interface 815/816/817 from a base station and/or determine its location based on the timing of the signals being received from two or more nearby base stations. The WTRU 802 may acquire location information by way of any suitable location-determination method while remaining consistent with an embodiment.

The processor 818 may further be coupled to other peripherals 838, which may include one or more software and/or hardware modules that provide additional features, functionality and/or wired or wireless connectivity. For example, the peripherals 838 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 8B depicts an example network entity 890 that may be used within a communication system. As depicted in FIG. 8B, network entity 890 includes a communication interface 892, a processor 894, and non-transitory data storage 896, all of which are communicatively linked by a bus, network, or other communication path 898.

Communication interface 892 may include one or more wired communication interfaces and/or one or more wireless-communication interfaces. With respect to wired communication, communication interface 892 may include one or more interfaces such as Ethernet interfaces, as an example. With respect to wireless communication, communication interface 892 may include components such as one or more antennae, one or more transceivers/chipsets designed and configured for one or more types of wireless (e.g., LTE) communication, and/or any other components deemed suitable by those of skill in the relevant art. And further with respect to wireless communication, communication interface 892 may be equipped at a scale and with a configuration appropriate for acting on the network side—as opposed to the client side—of wireless communications (e.g., LTE communications, Wi-Fi communications, and the like). Thus, communication interface 892 may include the appropriate equipment and circuitry (perhaps including multiple transceivers) for serving multiple mobile stations, UEs, or other access terminals in a coverage area.

Processor 894 may include one or more processors of any type deemed suitable by those of skill in the relevant art, some examples including a general-purpose microprocessor and a dedicated DSP.

Data storage 896 may take the form of any non-transitory computer-readable medium or combination of such media, some examples including flash memory, read-only memory (ROM), and random-access memory (RAM) to name but a few, as any one or more types of non-transitory data storage deemed suitable by those of skill in the relevant art may be used. As depicted in FIG. 8B, data storage 896 contains program instructions 897 executable by processor 894 for carrying out various combinations of the various network-entity functions described herein.

In some embodiments, the network-entity functions described herein are carried out by a network entity having a structure similar to that of network entity 890 of FIG. 8B. In some embodiments, one or more of such functions are carried out by a set of multiple network entities in combination, where each network entity has a structure similar to that of network entity 890 of FIG. 8B. Other network entities and/or combinations of network entities may be used in various embodiments for carrying out the network-entity functions described herein.

Note that various hardware elements of one or more of the described embodiments are referred to as “modules” that carry out (perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and those instructions may take the form of or include hardware (hardwired) instructions, firmware instructions, software instructions, and/or the like, and may be stored in any suitable non-transitory computer-readable medium or media, such as commonly referred to as RAM or ROM.

Although features and elements are described above in particular combinations, one of ordinary skill in the art will appreciate that each feature or element be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method, comprising:
detecting, by an approaching vehicle, blockage of an initial path;
in response to detecting the blockage, calculating at least one candidate path, and for each candidate path:
identifying at least one blocking vehicle along the candidate path;
sending, to the at least one blocking vehicle, a request for capability and surroundings information;
in response to the request, receiving respective responses from the at least one blocking vehicle, each response providing (i) an indication of permission to move the respective blocking vehicle, and (ii) three-dimensional data of the environment around the respective blocking vehicle; and
in response to a determination that (i) each of the blocking vehicles of the candidate path have indicated a permission to be moved, and (ii) the three-dimensional data of the environment around the blocking vehicles of the candidate path indicates feasibility of moving out of the way of the candidate path, selecting the candidate path as a bypass path;
sending, to each of the blocking vehicles of the bypass path, movement request information for causing each of the blocking vehicles of the bypass path to move out of the way of the bypass path; and
causing the approaching vehicle to move along the bypass path.

2. The method of claim 1, wherein the movement request information is sent only after:
sending, to each of the blocking vehicles of the bypass path, a pre-movement message identifying a corresponding requested movement; and
receiving confirmation from each of the blocking vehicles of the bypass path of an ability to perform the requested movement.

3. The method of claim 1, further comprising displaying, to a driver of the approaching vehicle, an animation of future movements of each of the blocking vehicles and of the approaching vehicle.

4. The method of claim 1,
wherein, for a first candidate path, the three-dimensional data indicates lack of feasibility to move a first one of the blocking vehicles of the first candidate path, and
wherein calculating at least one candidate path comprises calculating a second candidate path such that the first one of the blocking vehicles of the first candidate path is not a blocking vehicle of the second candidate path.

5. The method of claim 4, further comprising:
displaying a message indicating the second candidate path; and
receiving a user interface confirmation that indicates approval to use the second candidate path.

6. The method of claim 4, further comprising displaying, for the second candidate path, an animation of future movements of each of the blocking vehicles.

7. The method of claim 4, further comprising displaying a lack of feasibility to move by at least one of the blocking vehicles.

8. The method of claim 4, further comprising:
receiving, from at least one of the blocking vehicles, a cause of the lack of feasibility to move out of the way of the first candidate path; and
displaying a message indicating the cause that at least one of the blocking vehicles lacks feasibility to move out of the way of the first candidate path.

9. The method of claim 1, wherein the initial path is one of the at least one candidate paths.

10. The method of claim 1, further comprising:
displaying an icon indicating an estimated stopping location of the approaching vehicle;
displaying an icon indicating a future location of the approaching vehicle; and
displaying an icon for each of the blocking vehicles.

11. The method of claim 1, further comprising:
determining, for each of the blocking vehicles, the feasibility to move during a future time window; and
sending information to each of the blocking vehicles to delay moving out of the way of the bypass path until the future time window.

12. The method of claim 1, wherein determining, for each of the blocking vehicles, the feasibility of moving out of the way of the bypass path is based at least in part on information regarding road infrastructure.

13. The method of claim 1, wherein the approaching vehicle is a first approaching vehicle, and further comprising:
detecting a second approaching vehicle traversing along the bypass path;
sending, to each of the blocking vehicles, movement request information for causing each of the blocking vehicles to remain out of the way of the bypass path for the second approaching vehicle, after sending the movement request information for the first approaching vehicle; and
sending to the second approaching vehicle information for causing the second approaching vehicle to continue moving along the bypass path.

14. The method of claim 1, further comprising:
performing sensor readings by the approaching vehicle to add to the three-dimensional data of the environment around each vehicle,
wherein determining if one or more of the blocking vehicles is capable of moving out of the way of the bypass path based in part on the sensor readings performed.

15. An apparatus, comprising:
communications circuitry capable of vehicle-to-vehicle communication;
vehicle sensors;
sensor data processing units;
a processor; and
a non-transitory computer-readable medium storing instructions that are operative, when executed on the processor, to perform the functions of:
detecting, by an approaching vehicle, blockage of an initial path;
in response to detecting the blockage, calculating at least one candidate path, and for each candidate path:
identifying at least one blocking vehicle along the candidate path;
sending, to the at least one blocking vehicle, a request for capability and surroundings information;
in response to the request, receiving respective responses from the at least one blocking vehicle, each response providing (i) an indication of permission to move the respective blocking vehicle and (ii) three-dimensional data of the environment around the respective blocking vehicle; and
in response to a determination that (i) each of the blocking vehicles of the candidate path have indicated a permission to be moved; and (ii) the three-dimensional data of the environment around the blocking vehicles of the candidate path indicates feasibility of moving out of the way of the candidate path, selecting the candidate path as a bypass path;
sending, to each of the blocking vehicles of the bypass path, movement request information for causing each of the blocking vehicles of the bypass path to move out of the way of the bypass path; and
causing the approaching vehicle to move along the bypass path.
